(19) United States
(12) Patent Application Publication
(10) Pub. No.: US 2008/0056220 A1
(43) Pub. Date: Mar. 6, 2008

(54) SYSTEM AND METHOD FOR DETERMINING A CARRIER TO INTERFERENCE NOISE RATIO

(75) Inventors: Xiaoyong Yu, Grayslake, IL (US); Jian J. Wu, Reading (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/468,447

(22) Filed: Aug. 30, 2006

(51) Int. Cl. H04B 7/216

(52) U.S. Cl. 370/342

(57) ABSTRACT

An apparatus, method, and computer program product are provided for determining a carrier to interference-noise ratio (CINR) and received signal strength indicator (RSSI) in a wireless communication system. A base station calculates a carrier power (C) of at least one user in the wireless communication system, and a noise interference (NI) for one cell or sector in the wireless communication system. The carrier power (C) is divided by the noise interference (NI) to produce a value representative of the carrier to interference-noise ratio (C/NI). The received signal strength indicator (RSSI) is derived by combining weighted carrier power (C) and noise interference (NI).

### FIELD OF THE INVENTION

The present invention relates in general to wireless communications, and more specifically to systems and methods for accurately and efficiently calculating a Carrier to Interference-Noise Ratio (CINR) in a wireless system.

### BACKGROUND OF THE INVENTION

WiMAX is a term coined to describe standard, interoperable implementations of IEEE 802.16 wireless networks. In the IEEE 802.16 standard, a measurement is taken of a received signal strength indicator (RSSI), which is the measured power of a received signal, and the carrier to interference-noise ratio (CINR), which is the ratio of a desired signal power to noise power including both additive white Gaussian noise (AWGN) and other undesired interference. These measurements are typically sent back to the Base Station (BS) for air interference resource management.

In other cases, the base station may be required to compute an average received signal strength measurement per antenna for the purpose of identifying antenna failure conditions. The base station may need to separately compute an average uplink interference plus noise (NI) measurement and an average desired carrier signal power per uplink burst for more flexibility in a scheduler that resides in the base station.

While the RSSI measurement can be used by a base station for antenna failure condition detection, the received carrier power (C) per user and noise-interference (NI) measurements are used for radio resource management such as mobile transmit power control and modulation code scheme (MCS) selection in the Uplink (UL). Also, it is stated in the IEEE 802.16 standard that the estimated accuracy shall be within ±2 dB of the true value. However, no particular method is specified in the standard and the method for performing these measurements is left to individual implementations. Therefore, it is highly desired to derive a method that can meet the accuracy requirement while keeping implementation cost as low as possible.

In the IEEE 802.16 standard, a method is recommended for Carrier to Interference-Noise Ratio (CINR) measurement, which can be expressed as follows.

$$CINR = \frac{{\sum }_{n = 0}^{N - 1} {\vert {S}_{k , n} \vert}^{2}}{{\sum }_{n = 0}^{N - 1} {\vert {X}_{k , n} - {S}_{k , n} \vert}^{2}}$$

where X_{k,n} is a received sample n within signal k; S_{k,n} represents detected or pilot samples with channel state weighting; and N is the number of samples used in the estimate. This method results in an unbiased CINR estimate only if the channel state weighting (frequency domain coefficients of channel impulse response) is known. However, in practice the channel state weighting is estimated based on a preamble or a pilot embedded in data traffic. Due to the inevitable channel estimate error, the suggested method will likely cause the CINR estimate to be biased resulting in the CINR not meeting the accuracy requirement of within ±2 dB of the true value, especially for fading channels as shown in FIGS. 1 and 2 as explained below. Not meeting the CINR estimate accuracy requirement, may in turn, limit WiMax capacity and reduce system operation performance. Hence, there is a strong desire for accurate CINR measurement and there exists a need to overcome the problems with the prior art as discussed above.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a graph showing a CINR estimate using the IEEE 802.16 recommended method with MMSE channel estimates under AWGN.

FIG. 2 is a graph showing a CINR estimate using the IEEE 802.16 recommended method with MMSE channel estimates under a multi-path fading channel corresponding to a non-stationary mobile unit.

FIG. 3 a block diagram of a wireless communication system in accordance with one embodiment of the present invention.

FIG. 4 illustrates a tile structure in accordance with an embodiment of the present invention.

FIG. 5 is a block diagram illustrating a method for calculating CINR according to one embodiment of the present invention.

FIG. 6 is a block diagram illustrating a base station controller according to an exemplary embodiment of the present invention.

### DETAILED DESCRIPTION

An apparatus, method, and computer program product are provided for determining a carrier to interference-noise ratio (CINR) and received signal strength indicator (RSSI) in a wireless communication system. A base station calculates a carrier power (C) of at least one user in the wireless communication system, and a noise interference (NI) for one cell or sector in the wireless communication system. The carrier power (C) is divided by the noise interference (NI) to produce a value representative of the carrier to interference-noise ratio (C/NI). The received signal strength indicator (RSSI) is derived by combining weighted carrier power (C) and noise interference (NI).

As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the present invention.

Embodiments of the present invention provide systems and methods that solve a WiMax industry problem of efficiently and accurately calculating CINR estimates. By utilizing embodiments of the present invention, once carrier power (C) and noise-interference (NI) are calculated, the CINR can be easily determined.

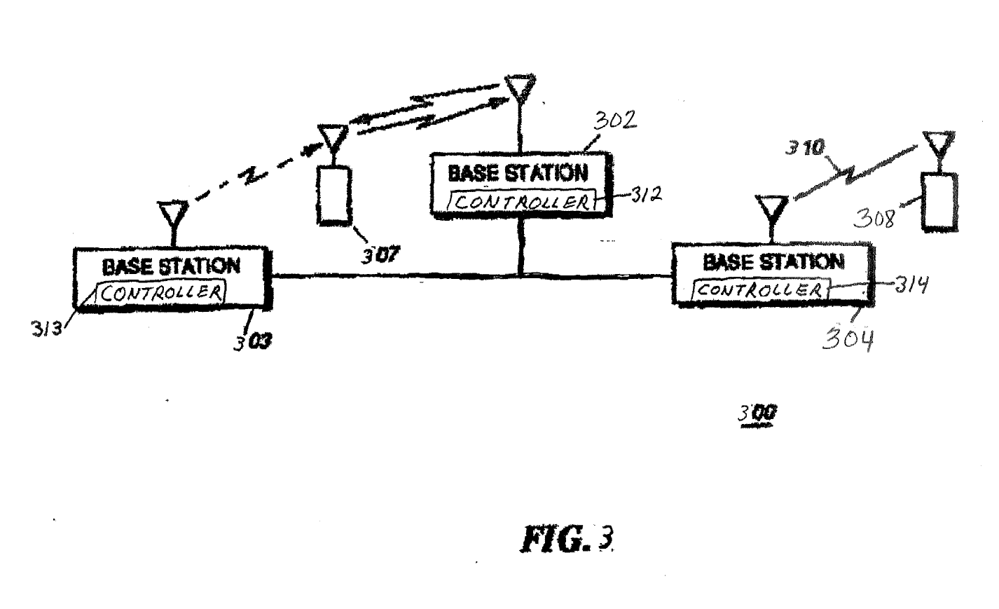

The following drawings will be helpful in understanding exemplary embodiments of the present invention. Referring now to FIG. 3, there is shown a block diagram of a wireless communication system in accordance with one embodiment of the present invention. The system 300 includes controllers 312, 313, and 314 coupled to base stations 302, 303, and 304, respectively. The base stations 302, 303, and 304 individually support portions of a geographic coverage area serving subscriber units or transceivers 307 and 308 (or “users”). In this embodiment, the subscriber units 307 and 308 (users) interface with the base stations (BS) 302, 303, and 304 using a TDMA communication protocol, however the present invention is not limited to any particular communication protocol or scheme.

Each base station is controlled by its corresponding controller. The controller handles allocation of radio channels, receives measurements from the subscriber units, and controls handovers from base station to base station. Additionally, databases for the sites, including information such as carrier frequencies, frequency hopping lists, power reduction levels, receiving levels for cell border calculation, are stored in, or communicatively coupled to, the controller.

A subscriber unit 307 (user) operating within the system 300 selects a particular base station as its primary interface for receive and transmit operations within the system. As a subscriber unit powers on or initially enters a service area, it searches for the best base station out of those within range to serve as the primary cell server. Similarly, when a subscriber unit moves between various geographic locations in the coverage area, a hand-off or hand-over may be necessary to another base station, which will then function as the new primary cell server. For example, subscriber unit 307 has base station 302 as its primary cell server, and subscriber unit 308 has base station 304 as its primary cell server. Preferably, a subscriber unit selects the base station that provides the best communication interface into the system. This ordinarily will depend on the signal quality of communication signals between a subscriber unit and a particular cell server.

In the IEEE 802.16 standard, the received signal strength indicator (RSSI) and CINR, which is the ratio of a desired signal power to noise power including both additive white Gaussian noise (AWGN) and other undesired interference, are very important signal measurements that must be determined by the mobile unit and optionally can be calculated by the base station.

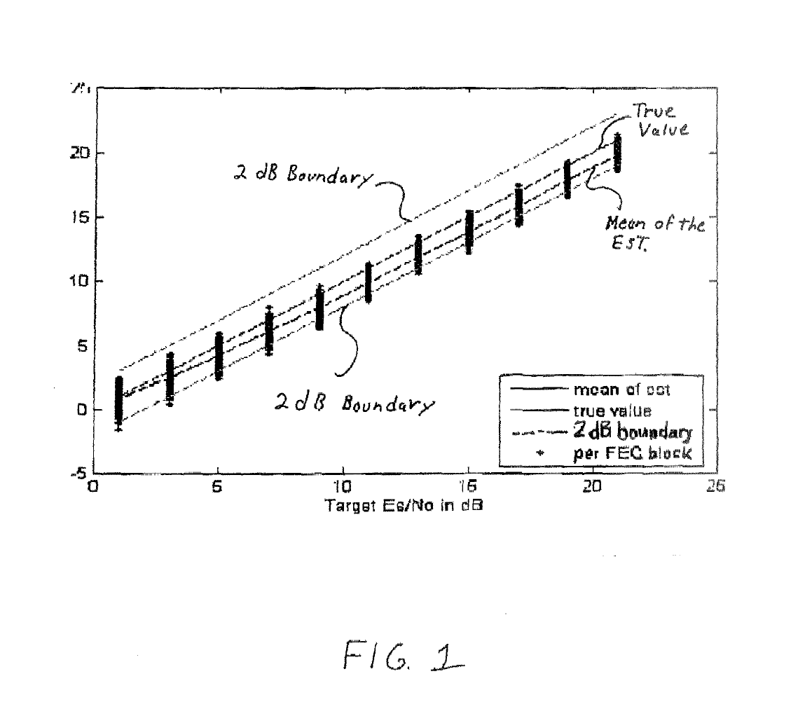

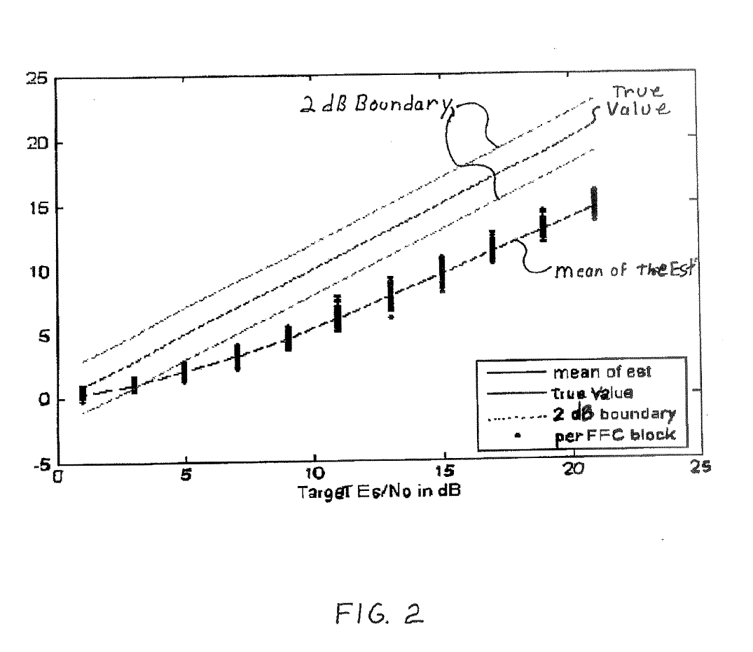

The graph of FIG. 1 shows the CINR estimated by using the method recommended by the standard under AWGN and using minimum mean-square error (MMSE) for channel estimate. In this example, the estimate is biased as the mean value of the estimation departs from the true value and does not always stay within the required ±2 dB. In the case of multi-path fading channels, the situation is even worse as shown in FIG. 2. Here, the International Telecommunication Union's typical Urban channel model with a mobile velocity of 50 km/h was used. As shown in the graph of FIG. 2, the estimated CINR value clearly departs from the true CINR value by more than 2 dB.

It is generally recognized that one method for RSSI measurement is to perform a brute-force received signal power accumulation, which is represented by the following formula.

$$RSSI = G \frac{1}{M} {\sum }_{i = 1}^{M} {\vert {y}_{i} \vert}^{2}$$

where G is total gain from antenna connector to Fast Fourier Transform (FFT), M is the number of samples used for the measurement, and yᵢ is complex valued ith sample input to FFT.

This method requires a considerable number of computations and is therefore not favored in an actual implementation. In embodiments of the present invention, the RSSI estimate is derived from the desired signal or carrier (C) and noise-interference (NI) estimates, thus saving the computation necessary for the signal-power accumulation in the brute-force RSSI estimation. More specifically, when C and NI are known, the RSSI can be determined as follows.

$$RSSI = \frac{1}{{N}_{fft}} {\sum }_{u = 1}^{U} {N}_{u} \times {C}_{u} + NI$$

where Cᵤ is the carrier signal power estimate for user u, N_{fft} is the FFT size in the system, Nᵤ is the number of tones used by user u, and NI is estimated noise and interference.

The method used in embodiments of the present invention for C and NI estimation is based on the fact that, due to the granularity of the WiMax UL data structure, the possibility of all tones being used in all UL frames is very small. Embodiments of the present invention utilize these unused or unassigned tones or slots that randomly scatter in the OFDM frequency-time grid in the UL. However, even in a hypothetical case where all UL tones are used for an occasional period of time, embodiments of the present invention are still valid if some tones or slots are intentionally reserved during that time by the scheduler (system manager) to facilitate the C and NI estimate. In other words, the scheduler can intentionally create some random fragments of tones that are not used by any user in the UL. This method can only be utilized by a base station for UL measurement. The noise-interference (NI) estimate is then calculated by accumulating the power of samples, after FFT, associated with those unused (or reserved) tones, then averaged over a relatively long time, as expressed by the following formula.

$${NI}_{long} = \frac{1}{M} {\sum }_{m ∈ B} {\vert {r}_{m} \vert}^{2}$$

where B is the set of unused tones and M is the number of elements in B and rₘ is associated samples in the unused tones.

The NI_{long} measurement is common for all users in a sector or cell. This is true if the unused tones randomly scatter across the entire OFDM frequency-time grid. The total interference can be modeled as additive white Gaussian noise within the signal bandwidth. The total interference of a cell is inter-cell and intra-cell interference and FFT-leakage caused by carrier frequency offsets, Doppler shifts, and multi-path fading of all users in the cell. Due to the UL tone hopping effect, in which physical tones used by a particular user randomly change across the whole frequency domain, in the WiMax system the FFT-leakage can be naturally characterized by AWGN. The averaged inter-cell and intra-cell interference can also be modeled as Gaussian noise for a period of time where the average for NI is calculated. This is more accurate when the number of interferers and number of unused tones that are used for NI_{long} calculation are large. After NI_{long} is averaged over a relatively long time (for example, 500 frames or 2.5 seconds), the estimate will capture the total interference and thermal noise in a cell, which is common to all users in the cell.

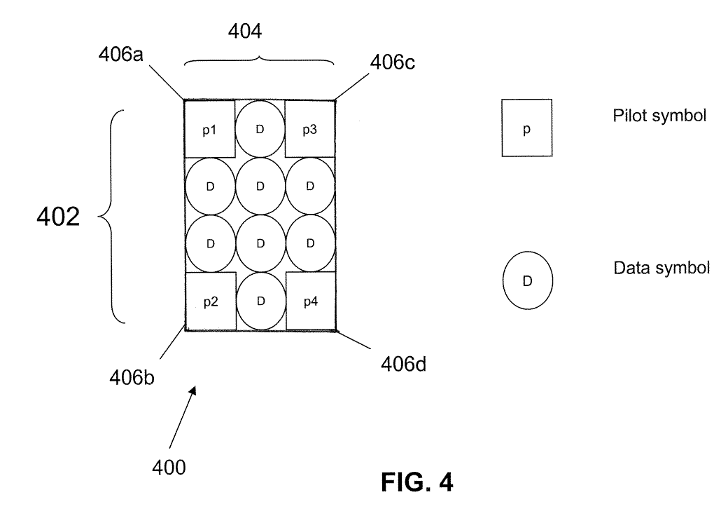

The C estimate is based on pilot symbols embedded in data traffic. For example, in the case of a Partial Usage Sub-Carrier (PUSC) mode, UL traffic is formed in a tile 400, shown in FIG. 4. The tile 400 contains 4 tones 402 and 3 OFDM symbols 404 where the corners 406a-d are used for the pilot symbols p1-p4. In the tile shown in FIG. 4, the rows represent tones and the columns represent OFDM symbols. Therefore, the 4 rows denote 4 tones and the 3 columns denote 3 OFDM symbols.

Consequently the C estimate is given in the following equation.

$${C}_{short} = \frac{1}{4 T} {\sum }_{t = 1}^{T} {\sum }_{i = 1}^{4} {\vert {p}_{t , i} {\hat{h}}_{t , i} \vert}^{2}$$

where Cₛₕₒᵣₜ indicates that the estimate is a short term value per user; T is the number of total tiles assigned to the interested user; and p_{t,i} and ĥ_{t,i} represent pilots and associated channel estimate in tile t. The channel estimate ĥ_{t,l} is calculated from a LS (least-square) estimate h̅_{t,l}=r_{t,i}/p_{t,i}, where r_{t,i} is a received sample at the position corresponding to pilot p_{t,i}, and an interpolation matrix becomes the following.

$$[ \begin{matrix}{\hat{h}}_{t , 1} \\ {\hat{h}}_{t , 2} \\ {\hat{h}}_{t , 3} \\ {\hat{h}}_{t , 4}\end{matrix} ] = [ \begin{matrix}{a}_{1 , 1} & {a}_{1 , 2} & {a}_{1 , 3} & {a}_{1 , 4} \\ {a}_{2 , 1} & {a}_{2 , 2} & {a}_{2 , 3} & {a}_{2 , 4} \\ {a}_{3 , 1} & {a}_{3 , 2} & {a}_{3 , 3} & {a}_{3 , 4} \\ {a}_{4 , 1} & {a}_{4 , 2} & {a}_{4 , 3} & {a}_{4 , 4}\end{matrix} ] \times [ \begin{matrix}{\tilde{h}}_{t , 1} \\ {\tilde{h}}_{t , 2} \\ {\tilde{h}}_{t , 3} \\ {\tilde{h}}_{t , 4}\end{matrix} ]$$

In general, the interpolation matrix can be derived by the minimum mean square error (MMSE) method for every tile. However, to save implementation cost, this interpolation matrix can be fixed for all tiles based on some average principle. For example, the matrix can be as follows.

$$[ \begin{matrix}0.5 & 0 & 0.5 & 0 \\ 0 & 0.5 & 0 & 0.5 \\ 0.5 & 0 & 0.5 & 0 \\ 0 & 0.5 & 0 & 0.5\end{matrix} ]$$

This matrix corresponds directly to the tile of FIG. 4, and for a different signal structure will be different in shape and size. Unlike the channel estimate for data demodulation where usually a MMSE method and complex-valued matrix inversion and multiplication are required, the channel estimate for the C calculation is very simple. Any additional computation load here is negligible, such as only bit shift and addition, since h̅_{t,i} is already calculated in the data demodulation.

Utilizing embodiments of the present invention, once carrier power (C) and noise-interference (NI) are calculated, the CINR can be easily determined as CINR=C/NI. Embodiments of the present invention also solve the WiMax industry problem of achieving an accurate CINR estimate. Simulation results indicate that RSSI, C, NI, and CINR estimates using an embodiment of the present invention are unbiased and meet the ±2 dB variation requirement set by the IEEE 802.16 standard.

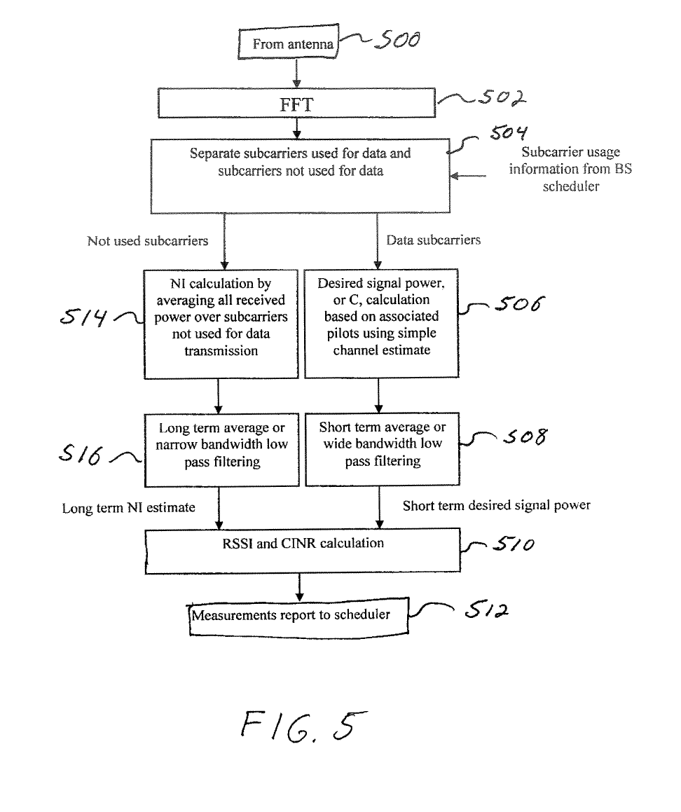

FIG. 5 is a process flow diagram of one embodiment of the present invention. The flow starts at step 500, where a signal is received at a base station via its receiving antenna. A FFT is performed on the signal in step 502. In step 504, subcarrier usage information is received from the base station scheduler. Based on the subcarrier usage information, all subcarriers can be divided into two categories: (1) used subcarriers that are assigned to a user for data delivery; and (2) unused subcarriers that are not assigned to any user. For those subcarriers used to carry data, the flow goes to step 506 where the desired signal power, or C, calculation is performed based on associated pilots using simple channel estimates. At the same time, those unused subcarriers, which are not assigned to any user to deliver data, go to step 514, where NI calculation is performed by averaging all received power over these unused subcarriers. In step 508, a short term average, or wide bandwidth low-pass filtering, is performed on the current desired signal power C. In step 516, a long term average or narrow bandwidth low pass filtering is performed on the current NI estimate. Both results are passed to step 510 for RSSI and CINR calculations. In step 512, the measurements are reported to the base station scheduler.

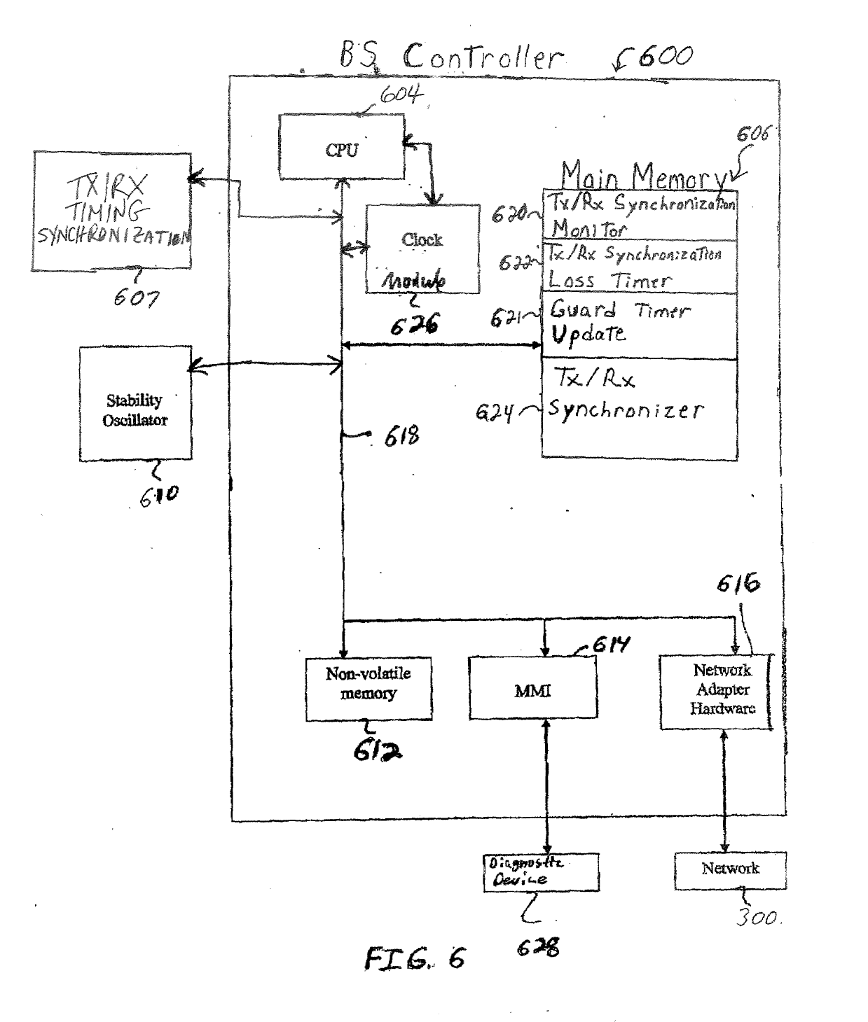

FIG. 6 is a block diagram illustrating a detailed view of a base station controller according to an exemplary embodiment of the present invention. The base station controller 600, in this embodiment, resides within its respective base station. In further embodiments, the base station controller 600 resides outside of and is communicatively coupled to its respective base station. The base station controller 600 includes a processor 604 that is communicatively connected to a main memory 606 (e.g., volatile memory), a TX/RX timing synchronization block 607, a stability oscillator 610, non-volatile memory 612, a man-machine interface (MMI) 614, a clock module 626, and network adapter hardware 616. A system bus 618 interconnects these system components.

The main memory 606 includes a TX/RX synchronization monitor 620, a TX/RX synchronization loss timer 622, a guard time updater 621, and a TX/RX synchronizer 624. These components can execute in the CPU 604 and parameters for these components can reside in the main memory 606, or they can be hardware components. The MMI 614, in this embodiment, is used to directly connect one or more diagnostic devices 628 to the base station controller 600.

The TX/RX timing synchronization block 607, in this embodiment, is a Global Positioning System (GPS) module, which provides a master clock source for the base station controller 600. More specifically, in this embodiment the CPU 604 receives the clock source from the GPS module 607 and passes this clock source to a clock module 626. Clock signals for the respective components of the base station are generated by the clock module 626 based on the master clock source received from the GPS module 607.

The master clock source provides a timing reference for the base station that is used to synchronize itself and its respective wireless communication devices for transmission and reception of wireless data. A TX/RX synchronizer 624 uses the timing reference to synchronize the base station for the wireless transmission and reception of data. Each of the base stations in the wireless communication system 300 is synchronized to a substantially common synchronization timing. In other words, the TX/RX timing synchronization block 607 communicatively coupled to each base station generates a substantially common synchronization timing signal. Therefore, the transmission and reception of data by each base station is synchronized with the other base stations in the wireless communication system. This base station synchronization allows downlink and uplink subframes in TDD communication frames transmitted by each base station to be aligned. In other words, the synchronization ensures that the wireless devices of one base station are not transmitting/receiving while the other wireless devices of the TDD system are transmitting/receiving.

In the current embodiment, the TX/RX timing synchronization is predefined and common among all of the base stations. The wireless communication devices that are coupled to the base station are also synchronized for transmission and reception of data. For example, the preamble of a downlink frame includes synchronization information for synchronizing one or more respective wireless communication devices.

The stability oscillator 610, in this embodiment, is a medium stability oscillator, a high stability oscillator, or the like. The stability oscillator 610 acts as a back-up synchronization device if the TX/RX timing synchronization block 607 fails or if a timing reference signal is lost for any reason. The stability oscillator 610 provides a timing frame of reference to the clock module 626. The stability oscillator 610 has a relatively slow drift rate (e.g., 0.8 μs per hour), which extends the survivability of the communications system 300. The synchronization of the base station with respect to a timing frame of reference that is common to the base stations is monitored by a TX/RX synchronization monitor 620 in this embodiment.

The TX/RX synchronization monitor 620 detects when a loss of the timing reference has occurred. A timing reference loss can occur, for example, from a failure of the TX/RX timing synchronization block 607, loss of the GPS signal, and the like. Once a loss is detected, a TX/RX synchronization loss timer 622 starts counting for a predefined time period. The TX/RX synchronization loss timer 622 is used to determine when a predefined period of time has passed since losing the time reference signal. In the current embodiment, the predefined period of time correlates to a known amount of time that the stability oscillator can drift (e.g., maximum clock slip rate) before potential interference between wireless devices occurs.

The guard time updater 621 helps mitigate interference. For example, in an 802.16e system utilizing TDD, a frame comprises, among other things, a downlink portion, an uplink portion, a transmit turn guard (TTG) portion, and a receive turn guard (RTG) portion. The transmit turn guard is a time period in which the wireless communication device is transitioning from a transmitting mode to a receiving mode. In other words, the wireless communication device stops transmitting so that it can receive data from the base station. The receive turn guard is a time period in which the wireless communication device is transitioning from a receiving mode to a transmitting mode.

The network adapter hardware 616 is used to provide an interface to the network 300. Embodiments of the present invention can be adapted to work with any data communications connections including present day analog and/or digital techniques or via a future networking mechanism.

Although the exemplary embodiments of the present invention are described above in the context of a fully functional computer system, those skilled in the art will appreciate that embodiments are capable of being distributed as a program product via floppy disk, CD ROM, or any other form of recordable media, or via any type of electronic transmission mechanism.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Although specific embodiments of the present invention have been disclosed, those having ordinary skill in the art will understand that changes can be made to the specific embodiments without departing from the spirit and scope of the present invention. The scope of the present invention is not to be restricted, therefore, to the specific embodiments, and it is intended that the appended claims cover any and all such applications, modifications, and embodiments within the scope of the present invention.

1. A method for determining a carrier to interference-noise ratio and a received signal strength indicator in a wireless communication system, the method comprising the steps of:
calculating, by a base station of the wireless communication system, a carrier power of at least one user in the wireless communication system;
calculating, by the base station, a noise interference for one cell or sector in the wireless communication system;
dividing the carrier power by the noise interference to produce a value representative of the carrier to interference-noise ratio; and
deriving the received signal strength indicator by combining a weighted carrier power and the noise interference.

2. The method according to claim 1, wherein the noise interference is calculated by the base station according to the formula:
$$NI = \frac{1}{M} {\sum }_{m ∈ B} {\vert {r}_{m} \vert}^{2}$$
where B is a set of unused tones, M is a number of elements in B, and rₘ is associated samples in the unused tones.

3. The method according to claim 2, wherein the set of unused tones is randomly scattered across an OFDM frequency-time grid.

4. The method according to claim 2, further comprising the step of reserving at least a portion of B so as to create random fragments of tones that are not used by any user in an uplink.

5. The method according to claim 2, wherein the noise interference is calculated by averaging values of NI over a time period.

6. The method according to claim 1, wherein the carrier power is calculated by the base station based on pilots associated with the at least one user according to the formula:
$$C = \frac{1}{4 T} {\sum }_{t = 1}^{T} {\sum }_{i = 1}^{4} {\vert {p}_{t , i} {\hat{h}}_{t , i} \vert}^{2}$$
where T is a number of total tiles assigned to the user; p_{t,i} represents a set of pilots in a tile t; and ĥ_{t,i} represents a set of channel estimates in a tile t.

7. The method according to claim 6,
wherein ĥ_{t,i} is calculated from a least-square estimate represented by ĥ_{t,i}=r_{t,i}/p_{t,i}, and
each r_{t,i} is a received sample at a position corresponding to one of the p_{t,i}.

8. The method according to claim 1, wherein the received signal strength indicator is derived according to the formula:
$$RSSI = \frac{1}{{N}_{fft}} {\sum }_{u = 1}^{U} {N}_{u} \times {C}_{u} + NI$$
where Cᵤ is the carrier signal power estimate for user u; N_{fft} is the FFT size in the system; Nᵤ is the number of tones used by user u; and NI is estimated noise and interference.

9. A base station for a wireless communication system, the base station comprising a processor configured to calculate a carrier power of at least one user in the wireless communication system; calculate a noise interference for one cell or sector in the wireless communication system; divide the carrier power by the noise interference to produce a value representative of the carrier to interference-noise ratio; and derive the received signal strength indicator by combining a weighted carrier power and the noise interference.

10. The base station according to claim 9, further comprising:
an input for receiving a plurality of power samples,
wherein the noise interference is calculated according to the formula:
$$NI = \frac{1}{M} {\sum }_{m ∈ B} {\vert {r}_{m} \vert}^{2}$$
where B is a set of unused tones, M is a number of elements in B, and rₘ is associated samples in the unused tones.

11. The base station according to claim 10, wherein the set of unused tones is randomly scattered across an OFDM frequency-time grid.

12. The base station according to claim 10, further comprising a scheduler for reserving at least a portion of B so as to create random fragments of tones that are not used by any user in an uplink.

13. The base station according to claim 9, wherein the carrier power is calculated based on pilots associated with the at least one user according to the formula:
$$C = \frac{1}{4 T} {\sum }_{t = 1}^{T} {\sum }_{i = 1}^{4} {\vert {p}_{t , i} {\hat{h}}_{t , i} \vert}^{2}$$
where T is a number of total tiles assigned to the user; p_{t,i} represents a set of pilots in a tile t; and ĥ_{t,i} represents a set of channel estimates in a tile t.

14. The base station according to claim 13,
wherein ĥ_{t,i} is calculated from a least-square estimate represented by ĥ_{t,i}=r_{t,i}/p_{t,i}, and
each r_{t,i} is a received sample at a position corresponding to one of the p_{t,i}.

15. A computer program product for determining a carrier to interference-noise ratio and a received signal strength indicator in a wireless communication system, the computer program product comprising a storage medium readable by a processing circuit and storing instructions for execution by the processing circuit for performing the steps of:
calculating, by a base station of the wireless communication system, a carrier power of at least one user in the wireless communication system;
calculating, by the base station, a noise interference for one cell or sector in the wireless communication system;
dividing the carrier power by the noise interference to produce a value representative of the carrier to interference-noise ratio; and
deriving the received signal strength indicator by combining a weighted carrier power and the noise interference.

16. The computer program product according to claim 15, wherein the noise interference is calculated by the base station according to the formula:
$$NI = \frac{1}{M} {\sum }_{m ∈ B} {\vert {r}_{m} \vert}^{2}$$
where B is a set of unused tones, M is a number of elements in B, and rₘ is associated samples in the unused tones.

17. The computer program product according to claim 15, wherein the computer program product further comprises instructions for performing the step of:
reserving at least a portion of B so as to create random fragments of tones that are not used by any user in an uplink.

18. The computer program product according to claim 15, wherein the noise interference is calculated by the base station by averaging values of NI_{long} over a time period.

19. The computer program product according to claim 14, wherein the carrier power is calculated by the base station according to the formula:
$$C = \frac{1}{4 T} {\sum }_{t = 1}^{T} {\sum }_{i = 1}^{4} {\vert {p}_{t , i} {\hat{h}}_{t , i} \vert}^{2}$$
where T is a number of total tiles assigned to a user; p_{t,i} represents a set of pilots in a tile t; and ĥ_{t,i} represents a set of channel estimates in a tile t.

20. The computer program product according to claim 15,
wherein ĥ_{t,i} is calculated from a least-square estimate represented by ĥ_{t,i}=r_{t,i}/p_{t,i}, and
each r_{t,i} is a received sample at a position corresponding to one of the p_{t,i}.
